(19) United States
(12) Patent Application Publication
(10) Pub. No.: US 2008/0065918 A1
(43) Pub. Date: Mar. 13, 2008

(54) POWER SAVING ELECTRONIC APPARATUS AND METHOD FOR SAVING POWER OF THE ELECTRONIC APPARATUS

(75) Inventors: SHIH-FANG WONG, Tu-Cheng (TW); JIAN-LIN LIU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 11/850,044

(22) Filed: Sep. 5, 2007

(30) Foreign Application Priority Data
Sep. 13, 2006 (CN) 200610062570.9

(51) Int. Cl. G06F 1/32

(52) U.S. Cl. 713/324

(57) ABSTRACT

A method for saving power of an electronic apparatus is provided. The apparatus includes an input unit for receiving operational inputs, a backlight unit for providing lighting, a setting table for recording relationship between operation modes and predetermined time periods. The method includes: reading a corresponding predetermined time period from the setting table according to a current operation mode; enabling or remaining enabling the backlight unit; and disabling the backlight unit when after a time period of not receiving operational inputs for the read predetermined time period.

### BACKGROUND

1. Technical Field

The present invention relates to electronic apparatus and particularly to power saving electronic apparatus and method therefor.

2. General Background

Portable electronic devices such as mobile phones and laptop computers are ubiquitous. However, the operating time of the batteries of the portable electronic devices limits their portability. If the capacity of the battery is predetermined, an effective way for prolonging the operating time of the battery is to minimize power consumption of the devices. Among the power consuming components of portable devices, backlights (e.g., keypad backlight and screen backlight) consumes an inordinate amount of power. Currently, an auto-turn off function is used to save power by turning off the backlights automatically if no input is received after a predetermined time.

However, the electronic device may have more than one operation modes, and each of the operation modes may need different predetermined times. For example, a message reading mode may need 10 seconds before the backlight turns off, while a phone answering mode may only need 1 second or may not even need the predetermined time. Accordingly, if a same predetermined time is used for the different operation modes, the device would still be wasting power by turning off the backlights in an operation mode after a relative long predetermined time where the device in fact only needs a short backlight time or no backlight at all. For example, the device may wait for 10 seconds before turning off the backlights after an answer key is pressed for answering a phone call. However, in most situations, the keypad or the screen is not needed at all when answering a phone call.

What is needed, therefore, is a power saving electronic apparatus and a method, through which the operating time of the battery of the electronic device can be prolonged.

### SUMMARY

A power saving electronic apparatus is provided. The apparatus includes an input unit for receiving operational inputs; a backlight unit for providing lighting; a storage unit for storing a setting table which records relationships between operation modes of the apparatus and predetermined time periods; and a microcontroller unit (MCU). The MCU includes an executing module for generating a mode signal indicative of a current operation mode; an acquiring module for detecting the current operation mode according to the mode signal, and for reading a corresponding predetermined time period from the setting table according to the current operation mode; and a backlight controlling module for controlling the backlight unit to be disabled when after a time period of not receiving operational inputs for the read predetermined time period.

A method for saving power of an electronic apparatus is also provided. The apparatus includes an input unit for receiving operational inputs, a backlight unit for providing lighting, a setting table for recording relationship between operation modes and predetermined time periods. The method includes: reading a corresponding predetermined time period from the setting table according to a current operation mode; enabling or remaining enabling the backlight unit; and disabling the backlight unit when after a time period of not receiving inputs for the read predetermined time period.

Other advantages and novel features will be drawn from the following detailed description with reference to the attached drawing.

### BRIEF DESCRIPTION OF THE DRAWINGS

FIG. 1 is a block diagram of a hardware infrastructure of a power saving electronic apparatus;

FIG. 2 illustrates an exemplary setting table in accordance with the present invention; and

FIG. 3 is a flowchart of a preferred method for saving power, while utilizing the apparatus of FIG. 1.

### DETAILED DESCRIPTION OF THE EMBODIMENT

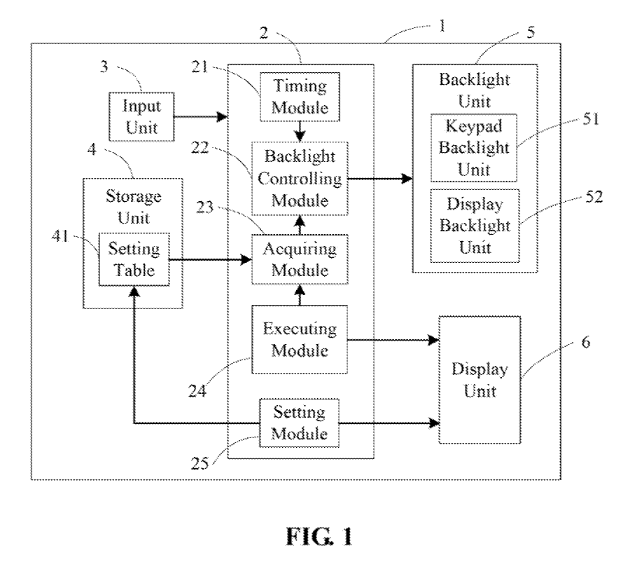

FIG. 1 is a block diagram of a hardware infrastructure of a power saving electronic apparatus in accordance with a preferred embodiment of present invention. The power saving electronic apparatus 1 (hereinafter “the apparatus 1”) is a battery powered electronic device such as a mobile phone, a portable media player, a laptop computer, etc. For simplicity, in the preferred embodiment, the apparatus 1 is assumed to be mobile phone. The apparatus 1 is configured with a plurality of application programs (e.g., video play program, image display program) for performing particular functions, and each of the application programs is associated with an operation mode of the apparatus 1, such as a video play mode, an audio play mode, a game mode, a phone answer mode, and a message read mode. That is, in each of the operation modes, the apparatus 1 is operable to perform the particular function.

The apparatus 1 includes a microcontroller unit (MCU) 2, an input unit 3, a storage unit 4, a backlight unit 5, and a display unit 6. The input unit 3 is configured for receiving operational inputs from users. Typically, the input unit 3 is a keypad. The backlight unit 5 is configured for providing lighting. The backlight unit 5 includes a keypad backlight unit 51 and a display backlight unit 52. The keypad backlight unit 51 is configured for illuminating the keypad 3 of the apparatus 1. The display backlight unit 52 is configured for illuminating the display unit 6.

The MCU 2 includes a timing module 21, a backlight controlling module 22, an acquiring module 23, an executing module 24, and a setting module 25. The timing module 21 is configured for counting a time period. The executing module 24 is configured for running the application programs, thus performing corresponding functions of the operation modes. The executing module 24 further generates a mode signal that indicates a current operation mode of the apparatus 1.

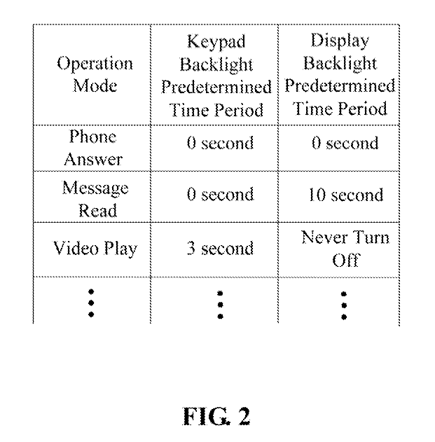

The setting module 25 is configured for assigning predetermined time periods to each of the operation modes, namely setting relationships between the operation modes and the predetermined time periods. Each of the operation modes can be set with a corresponding predetermined time period, i.e., different operation modes may have different predetermined time periods. Furthermore, in the same operation mode, the keypad backlight unit 51 and the display backlight unit 52 can be set with different predetermined time periods. For example, in the video play mode, the display unit 6 displays video information while the keypad 3 is idle, consequently, the display backlight unit 52 needs to remain enabled while the keypad backlight unit 51 can be set with a predetermined time period of 3 seconds. The setting module 25 further stores the relationships into a setting table 41 (see FIG. 2) in the storage unit 4.

The acquiring module 23 is configured for detecting the current operation mode according to the mode signal generated by the executing module 24, and for reading the corresponding predetermined time periods from the setting table 41 according to the current operation mode. The backlight controlling module 22 is configured for controlling the backlight unit 5 to be enabled or to remain enabled while the input unit 3 receives the operational inputs, and for disabling the backlight unit 5 based on not receiving operational inputs from users for the read predetermined time period.

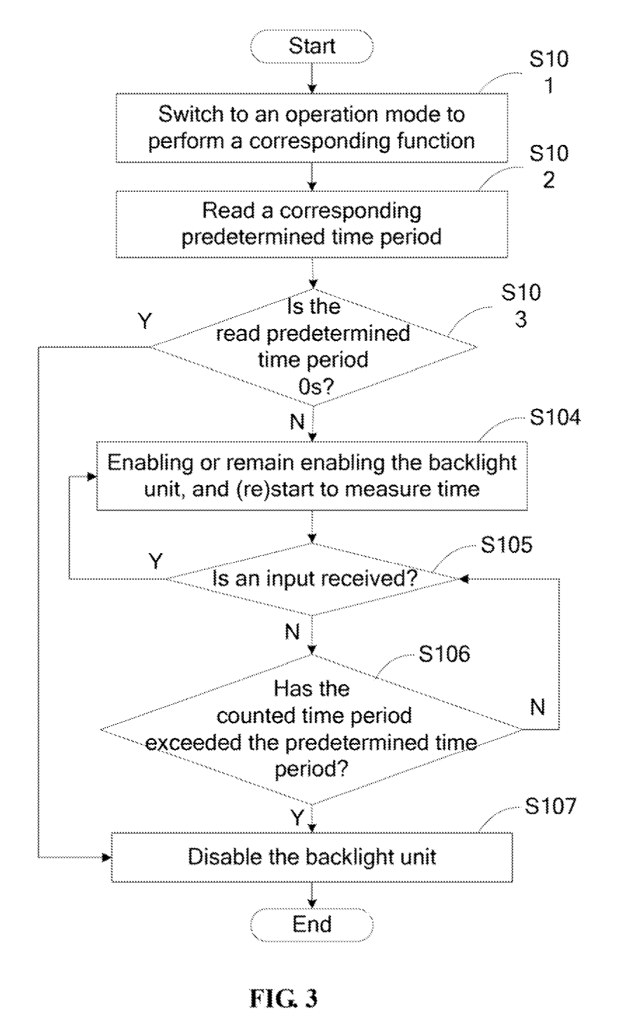

FIG. 3 is a flowchart of a preferred method for saving power by utilizing the power saving electronic apparatus of FIG. 1.

In step S101, the executing module 24 controls the apparatus 1 to switch to an operation mode to perform the corresponding function while the input unit 3 receives an operational input from users, and generates the mode signal that indicates the current operation mode of the apparatus 1.

In step S102, the acquiring module 23 detects the current operation mode according to the mode signal, and reads the corresponding predetermined time period from the setting table 41 according to the current operation mode indicated by the mode signal.

In step S103, the backlight controlling module 22 determines whether the read predetermined time period is 0 seconds, which means backlight is not needed in the current operation mode.

If the read predetermined time period is 0 seconds, the procedure goes to step S107 described below.

If the read predetermined time period is not 0 seconds, in step S104, the backlight controlling module 22 controls the backlight unit 5 to be enabled or remain enabled, and the timing module 21 starts or restarts to count a time period.

In step S105, the input unit 3 determines whether an input is received.

If an input is received, the procedure goes back to step S104, the timing module 21 restarts to count a time period.

If no operational inputs are received, in step S106, the timing module 21 determines whether the counted time period has exceeded the read predetermined time period.

If the counted time period has not exceeded the read predetermined time period, the procedure goes back to S105 described above.

If the counted time period has exceeded the read predetermined time period, in step S107, the backlight controlling module 22 controls the backlight unit 5 to turn off.

Therefore, by utilizing the apparatus 1, backlight can be automatically turned off in unnecessary operation modes, thereby saving power consumption of the apparatus 1 and prolonging the use life time of the apparatus 1.

Although the present invention has been specifically described on the basis of a preferred embodiment including a preferred method thereof, the invention is not to be construed as being limited thereto. Various changes or modifications may be made to the embodiment including the method without departing from the scope and spirit of the invention.

What is claimed is:

1. A power saving electronic apparatus comprising:
an input unit configured for receiving operational inputs;
a backlight unit configured for providing lighting;
a storage unit configured for storing a setting table which records relationships between operation modes of the apparatus and predetermined time periods; and
a microcontroller unit (MCU), comprising:
an executing module configured for generating a mode signal that indicates a current operation mode of the apparatus;
an acquiring module configured for detecting the current operation mode according to the mode signal, and for reading a corresponding predetermined time period from the setting table according to the current operation mode; and
a backlight controlling module configured for enabling or remain enabling the backlight unit while the input unit receives the operational inputs, and for disabling the backlight unit when after a time period of not receiving operational inputs for the read predetermined time period.

2. The apparatus according to claim 1, further comprising a timing module configured for counting a time period to indicate the predetermined time period.

3. The apparatus according to claim 1, wherein the MCU further comprises a setting module configured for setting the relationships between the operation modes and the predetermined time periods.

4. The apparatus according to claim 1, wherein the backlight unit comprises a keypad backlight unit configured for illuminating a keypad of the apparatus, and a display backlight unit configured for illuminating a display unit of the apparatus.

5. The apparatus according to claim 4, wherein the keypad backlight unit and the display backlight unit are set with different predetermined time periods correspondingly in each of the operation modes.

6. A method for saving power of an electronic apparatus, wherein the apparatus comprises an input unit configured for receiving operational inputs, a backlight unit configured for providing lighting, a setting table for recording relationships between operation modes of the apparatus and predetermined time periods, the method comprising:
reading a corresponding predetermined time period from the setting table according to a current operation mode;
enabling or remain enabling the backlight unit; and
disabling the backlight unit when after a time period of not receiving operational inputs for the read predetermined time period.

7. The method according to claim 6, further comprising:
setting the relationships between the operation modes and the predetermined time periods.

8. The method according to claim 6, wherein the backlight unit comprises a keypad backlight unit configured for illuminating a keypad of the apparatus, and a display backlight unit configured for illuminating a display unit of the apparatus; the method further comprising:
setting the keypad backlight unit and the display backlight unit with different predetermined time periods corresponding to each of the operation modes.
